(19) United States
(12) Patent Application Publication
(10) Pub. No.: US 2008/0252606 A1
(43) Pub. Date: Oct. 16, 2008

(54) Display Device

(75) Inventors: Murray Gillies, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,517

(22) PCT Filed: May 3, 2005
(86) PCT No.: PCT/IB2005/051429

§ 371 Date: Oct. 31, 2006

(30) Foreign Application Priority Data
May 5, 2004 (EP) 04101925.8

(51) Int. Cl. G06F 3/041

(52) U.S. Cl. 345/173

(57) ABSTRACT

A matrix display device (32) comprising at least one structured layer, arranged on a substrate and formed so as to include a code (31), detectable by a pointing device (33) to determine a position on the display (32). Providing the pixel structure with a location code can be achieved by relatively simple modifications of the manufacturing process. Therefore, the code can be incorporated in the display device in a very cost efficient manner, typically not increasing the manufacturing cost of a conventional matrix display. It will therefore either reduce the cost price of devices where a touch screen is already present or greatly improve the functionality of many products where a touch screen is at present too expensive.

The present invention relates to a matrix display device comprising at least one structured layer, disposed on a substrate to form a pixel structure. In particular, the invention relates to such displays intended for use as a touch screen.

Traditionally, touch screens have been based on sensing of a pressure, applied by e.g. a finger or a pointing device. Such sensing can make use of local changes in capacitance or resistance between two foils mounted on top of the screen. Other alternative solutions involve ultrasonic detection of a pointer, or surface acoustic wave detection. In essence, however, the concept is that the device, being for example the hand held computer, uses a detection mechanism to determine the position of either a pointer (such as in a Palm computer) or a finger.

A drawback with such sensing is that each screen that requires touch screen functionality must be equipped with the sensing mechanism. If those sensing mechanisms are different, this requires use of different pointing devices.

Recently, a pointing device technology has been developed by Anoto AB, described in the patent U.S. Pat. No. 6,502,756 and in the published application US 2003/0061188. The technology involves a pointing device (in the form of a pen) adapted to register its position in relation to a coded pattern preprinted on a paper or the like.

A pen and paper according to this technology is marketed by Logitech. The location code on the paper comprises dots situated on a matrix with a spacing of 300 um in both the X and Y directions. Code information is contained in the exact position of each dot which can be offset by 100 um in either of the four compass directions. If one considers a randomly chosen array of 5×5 dots then the variations in the positions of the dots gives a unique location code on the paper. The pen uses an infra red illumination source and a CCD camera to read the codes at a frequency of 100 Hz. Such a pen can be used to write a hardcopy on the paper, while simultaneously making a soft copy of what's being written.

It is an object of the invention to provide a cost efficient alternative to conventional touch screens.

This and other objects are achieved by a matrix display device comprising at least one structured layer, disposed on a substrate to form a pixel structure, wherein this layer is formed so as to include a code, detectable by a pointing device to determine a position on the display.

According to the invention, any periodic pixel structure formed on a substrate of a display can be provided with a location code readable by a pointing device. The code can be essentially of the kind described in U.S. Pat. No. 6,502,756, but is not limited to this type of code.

As the code is implemented in the display structure device itself, no adaptation of the driver or application software is required.

Providing the pixel structure with a location code can be achieved by relatively simple modifications of the manufacturing process. Therefore, the code can be incorporated in the display device in a very cost efficient manner, typically not increasing the manufacturing cost of a conventional matrix display. It will therefore either reduce the cost price of devices where a touch screen is already present or greatly improve the functionality of many products where a touch screen is at present too expensive.

The location codes will not be visible to the eye as we are merely adapting components of the display that are already of such fine feature size that they are not visible to the naked eye. This means that the user is not forced to use the pointer option and that the code can “secretly” be in the display without the user knowing.

The pixel structure layer can be a pixel matrix layer of the display device, such as a black matrix (row and column dividers), capacitance lines, pixel wall encapsulation, transistor (TFT) layer, storage capacitors, etc.

The pixel structure layer can also be disposed externally of a pixel matrix layer, such as a color filter, a front light reflection layer, or a polarizer layer arranged on top of the display.

The layer can be disposed using lithographic techniques, or printing techniques (offset, contact or inkjet printing).

According to a preferred embodiment, the layer comprises a grid of two sets of parallel lines delimiting a plurality of pixel areas, and the code comprises fields associated with said parallel lines and extending into said pixel areas. The fields can be solid blocks, or be protrusions in the lines. This latter alternative makes it possible to vary the form of each pixel so as to result in a unique code when read together with the neighboring pixels, while at the same time preserving the pixel area of each pixel. Basically, what is lost in area on a side with an intruding line can be gained on a side with a protruding line.

The fields can be located adjacent to intersections of the parallel lines, or in between such intersections.

The device can be self emissive, i.e. not requiring an external light source to generate an image. Such displays include backlight based displays like LCD displays, light guide displays such as dynamic foil displays, and LED displays like organic LED displays. Compared to prior art, this has the advantage that the pointing device does not require any illumination source such as an infra red LED to illuminate the codes.

This and other aspects of the present invention will now be described in more detail, with reference to the appended drawings showing a currently preferred embodiment of the invention.

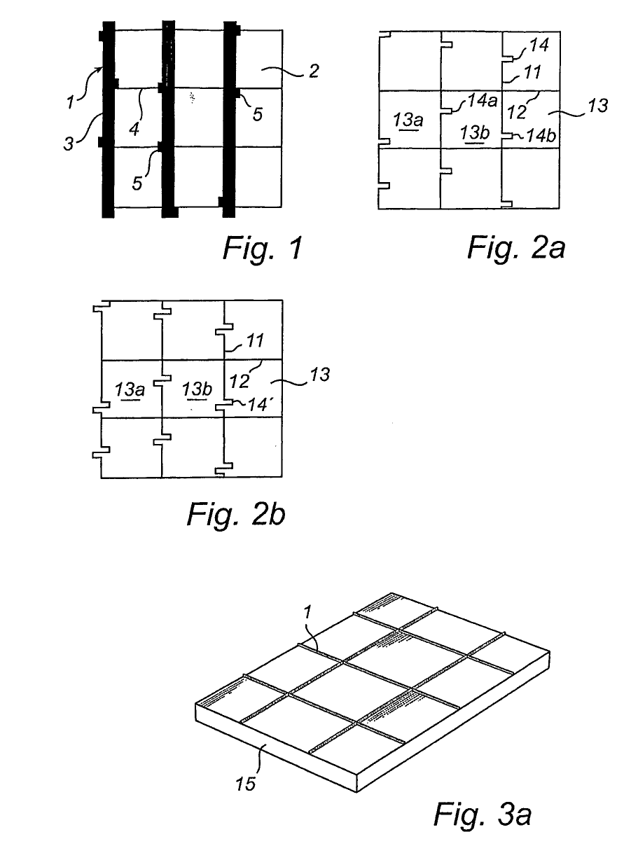

FIG. 1 shows a black matrix according to a first embodiment of the invention.

FIG. 2 shows a pixel layout according to a second embodiment of the invention.

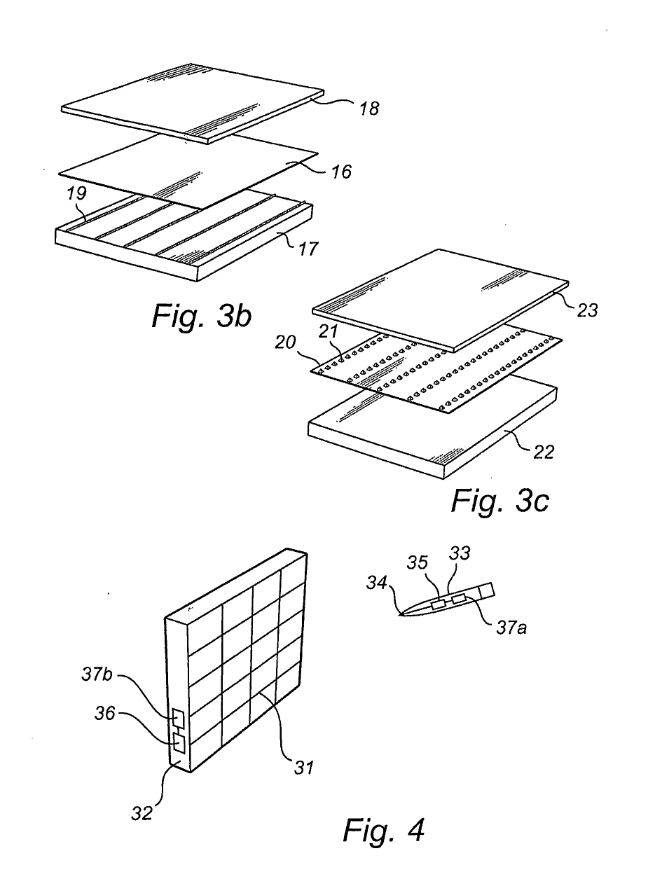

FIGS. 3a, 3b and 3c each show applications of the invention on different display types.

FIG. 4 shows a display device and a pointing device according to an embodiment of the invention.

A first embodiment of the invention is shown in FIG. 1, in the form of a black matrix layer 1. The black matrix comprises two sets of parallel lines 3, 4, defining the pixels 2 in a display. The display can be for example an LCD display but similar pixel structures are present in other matrix type displays, such as a organic LED display. The display is preferably emissive, either by means of light emitting elements by them selves capable of emitting light, or by means of a light source coupled to a plurality of pixel elements. The first category includes any LED display, while the second category includes displays with a back light, such as LCD displays, and displays with a light guide coupled to a light source, such as dynamic foil displays.

The black matrix according to this embodiment of the invention includes small blocks 5 at the crossing points of the lines 3, 4. These blocks are positioned to the left or right of the matrix in the horizontal direction and/or to the middle, up or down in the vertical. There is also one central position. This gives in total a 7-bit code rather than the 9-bit code of the Logitech paper mentioned above. If, however, a larger number of bits are required then there are many other options, e.g. extra positions in either the vertical or the horizontal directions.

A black matrix is typically manufactured in a lithography process, where the desired matrix pattern is transferred to a substrate from a lithographic exposure mask. The code illustrated in FIG. 1 can thus be incorporated in the black matrix by simply changing the lithographic exposure mask, hence requiring no additional processing steps leading to a cost efficient manufacturing process.

Another embodiment of the invention is shown in FIGS. 2a and 2b. Here, the dividing lines 11, 12 between pixels 13 are not straight, but presents protrusions 14, preferably rectangular or triangular in shape, extending into one of the neighboring pixels, thereby resulting in a varying form of the pixels. In the illustrated example, only the vertical lines 11 are provided with such protrusions 14, and the vertical position is varied to form the location code. The number of protrusions 14 and their different positions on each pixel side can be determined by the skilled man in order to obtain a sufficient number of code combinations.

The protrusion 14a from one pixel 13a into a neighboring pixel 13b results in one pixel area 13a being extended at the expense of the other pixel area 13b. However, if the pixel 13b on its other side is provided with another protrusion 14b, extending its pixel area, these protrusions 14a, 14b will compensate each other. Generally speaking, if each pixel has the same number of sides provided with protrusions (e.g. its both vertical sides), the effects from these protrusions will be equal for all pixels (see FIG. 2a). Alternatively, each protrusions can be simultaneously compensated by an inclusion to form e.g. a rectangular or triangular “S”-shape 14′, in which case it does not affect the area of the pixels at all (see FIG. 2b).

The shape of pixels is typically also defined in a lithography process, whereby the embodiment in FIGS. 2a and 2b can also be realized very cost efficiently. In this process, the black matrix 1 is disposed on a substrate 15 as shown in FIG. 3a.

Although the invention has now been described in relation to a black matrix, other applications are possible, using other pixel structures in a matrix type display. For example, the position and shape of capacitance lines, transistors (e.g. thin film transistors) or storage capacitors can be varied in the same way (changing the lithography mask) in order to realize a location code as described above. Also, certain color filters embodied using lithography may be used.

Moreover, the invention is not limited to pixel structure layers being formed by lithography. On the contrary, many other types of layers can be used to realize the invention.

For example, different types of printing techniques may be used, such as offset printing, contact printing and ink-jet printing. A black matrix as described above may be printed as well as disposed in a lithography process. Typical other structures which are printed on a substrate in matrix type displays include pixel wall encapsulation, certain color filters and barrier ribs. In addition to these layers, organic LED displays include layers for printing dams and cathode separators, also suitable to realize the invention. A further possible realization of the invention relates to molded structures, which are present in e.g. dynamic foil displays and front light displays.

In a dynamic foil display, shown schematically in FIG. 3b, an electromechanically operable foil 16 is arranged between a light guide 17 and a passive plate 18, and held in place by spacers 19 aligned with electrodes (not shown) for operating the foil. The spacers 19 may be molded integrally with the light guide, or be printed in the light guide using any of the above mentioned techniques. According to one embodiment of the invention, these spacers are formed to include the location code, e.g. in a way as described above.

In a front light display, shown schematically in FIG. 3c, a plate 20 formed with light scattering formations 21, e.g. pyramids or notches, couples light out from a light guide 22 to a reflective display 23. In this case, the scattering formations can then be formed to include the location code, e.g. in a way as described above. Note that the pyramids (or notches) do not necessarily have to have the same periodicity as the pixel structure.

FIG. 4 shows how the location code 31 incorporated in a display 32 according to the invention can be read by a pointing device 33. In the preferred embodiments, the display generates light by itself, and the pointing device does thus not require any light source to illuminate the code, only a light sensing device 34 connected to a processor 35. In principle, this requires that all pixels in the area of interest emit light, as the code otherwise will not be visible, but in practice this will not be a problem. First of all, an area of interest will typically display some kind of information, thus having a significant portion of the pixels emitting light. Secondly, even pixels that are turned off will normally leak a small amount of light, which should be enough to detect the code. Finally, even if a number of pixels are so dark that the code can not be detected by the pointing device, a unique code pattern can normally still be detected, at least if the area of detection includes a sufficient number of pixels.

As the position sensing task is now performed by the pointing device 33, the position data acquired needs to be transferred back to the processor 36 of the display device 32 in order to affect the data displayed (e.g. change menus, execute display commands, etc). Such, preferably cordless, communication can be achieved in any number of ways. In a preferred embodiment, the pointing device 33 and display device 32 are equipped with Blue Tooth circuits 37a, 37b providing communication according to the BlueTooth protocol. This solution facilitates using the same pointing device with several different display devices (TV set, phone, personal digital assistant, etc).

The person skilled in the art realizes that the present invention by no means is limited to the preferred embodiments described above. On the contrary, many modifications and variations are possible within the scope of the appended claims. For example, the invention can be applied to other types of displays than the ones shown in FIGS. 3a-3c, such as plasma displays and organic LED displays. The details of the pointing device can also differ from the example disclosed with reference to FIG. 4, including for example different sensing, processing and/or communication possibilities. Depending on the sensing technology used, the structure implementing the code may be reflective, emissive, or a combination thereof.

1. A matrix display device (32) comprising at least one structured layer (1; 19; 20), arranged on a substrate (15; 17; 22), characterized in that said layer (1) is formed so as to include a code (31), detectable by a pointing device (33) to determine a position on the display.

2. A display device according to claim 1, wherein said structure is pixel structure.

3. A display device according to claim 2, wherein said layer constitutes a pixel matrix layer (1) of the display device.

4. A display device according to claim 1, wherein said layer is disposed externally of a pixel matrix layer.

5. A display device according to claim 1, wherein said layer is formed by a lithographic technique.

6. A display device according to claim 1, wherein said layer is formed by printing.

7. A display device according to claim 1, wherein said layer (1) comprises at least one set of parallel lines delimiting a plurality of pixel areas (2), and said code comprises fields (5; 14) associated with said parallel lines and extending into said pixel areas.

8. A display device according to claim 7, wherein said fields (5) are solid.

9. A display device according to claim 7, wherein said fields are formed as protrusions (14) in said parallel lines.

10. A display device according to claim 9, wherein one protrusion (14a) reducing the size of a pixel area (13b) is at least partially compensated by a second protrusion (14b) extending the size of said pixel area (13b), so that the pixel area (13b) remains essentially unchanged.

11. A display device according to claim 7, wherein said fields are located adjacent to intersections of said parallel lines.

12. A display device according to claim 7, wherein said fields are located between intersections of said parallel lines.

13. A display device according to claim 1, wherein said display (32) is self-emissive.

14. A display device according to claim 1, wherein said display (32) comprises an integrated illumination system.
